(19) United States
(12) Patent Application Publication
(10) Pub. No.: US 2023/0269531 A1
(43) Pub. Date: Aug. 24, 2023

(54) UNDERWATER BLUETOOTH HEADPHONES FOR AQUATIC ENVIRONMENTS

(71) Applicant: Finnovate Group LLC, Solana Beach, CA (US)

(72) Inventor: Kari Kristian Rauhala, Solana Beach, CA (US)

(21) Appl. No.: 18/172,996

(22) Filed: Feb. 22, 2023

Related U.S. Application Data
(60) Provisional application No. 63/312,733, filed on Feb. 22, 2022.

(51) Int. Cl. H04R 1/44; H04R 5/033; H04R 5/04

(52) U.S. Cl. CPC H04R 1/44; H04R 5/0335; H04R 5/04; H04R 2420/07; H04W 4/80

(57) ABSTRACT

A wireless communication apparatus and system for an aquatic environment. An apparatus includes a base having one or more wireless receiver antennas, and a first attachment mechanism connected with the base for receiving and holding a wireless transmitter. The wireless transmitter has one or more wireless transmission antennas for transmitting audio signals, and the first attachment mechanism is configured to position the one or more wireless transmission antennas of the wireless transmitter within less than approximately 20 centimeters from the one or more wireless receiver antennas of the base. The apparatus further includes one or more earphones connected with the base, each of the one or more earphones having a speaker for providing the audio signals from the wireless transmitter to a wearer’s ears.

### CROSS REFERENCE TO RELATED APPLICATIONS

This application claims the benefit of U.S. Provisional Application 63/312,733, filed Feb. 22, 2022, which is incorporated by reference.

### BACKGROUND

Bluetooth (BT) is a name for a short-range, low power consumption, wireless transmission technology, for transmitting signals in “personal area networks” between two devices over short distances using ultra-high frequency (UHF) radio waves in the industrial, scientific and medical (ISM) bands, i.e., such as between 2.4 to 2.48 GHz. BT is one of the most widely used signal transmission standards, particularly for devices such as audio player devices, headphones, mobile phones, and the like. In its most often-used transmission mode, BT transmission power is limited to 2.5 milliwatts, providing it with a fairly short range of only up to about 10 meters.

However, despite the widespread use of Bluetooth-enabled devices, BT transmission propagation in water is attenuated very quickly, mainly due to the 2.4 GHz transmission frequency. In underwater use, a normal BT transmission is only able to propagate about 15-20 cm. For underwater use, the source of the BT transmission and the receiver must be within this range, or the transmission will fail. Thus, BT devices are very rarely used in an aquatic environment.

Accordingly, what is needed for is an apparatus and system for using BT transmissions in an aquatic environment.

### SUMMARY

This document describes Bluetooth (BT) headphones that have an attachment mechanism for a digital player for underwater use. In some preferred implementations, an apparatus includes an attachment mechanism to attach a digital audio player (BT transmitter) on the BT headphones, where the distance between the transmitting and receiving BT antennas is short, i.e., approximately 20 cm or less.

In some aspects, a wireless communication apparatus includes a base having one or more wireless receiver antennas, and a first attachment mechanism connected with the base for receiving and holding a wireless transmitter. The wireless transmitter has one or more wireless transmission antennas for transmitting audio signals, and the first attachment mechanism is configured to position the one or more wireless transmission antennas of the wireless transmitter within less than approximately 20 centimeters from the one or more wireless receiver antennas of the base. The apparatus further includes one or more earphones connected with the base, each of the one or more earphones having a speaker for providing the audio signals from the wireless transmitter to a wearer’s ears.

In other aspects, the apparatus further includes a second attachment mechanism connected with the base, the second attachment mechanism being configured to attach to an object to position the apparatus on the wearer’s head. Further still, the base can include one or more user controls for controlling one or more aspects of the audio signals.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 illustrates an example of a BT headphones with Smart Watch. The attachment mechanism base has a built-in BT receiver that is close to the Smart Watch BT antenna;

FIG. 2 shows BT headphones with an elastic attachment system for a smart watch;

FIG. 3 shows BT headphones attached to swim goggles; and

FIG. 4. shows BT headphones with bone conduction speakers.

Like reference symbols in the various drawings indicate like elements.

### DETAILED DESCRIPTION

This document describes an apparatus for enabling Bluetooth (BT) transmissions in an aquatic environment. The apparatus includes BT headphones that have an attachment mechanism configured to receive and hold a digital audio player with one or more BT transmission antennas for underwater use. The BT headphones can include a base having one or more BT receiving antennas and an amplifier. The base can be connected to, or integrated with, the attachment mechanism. In some implementations, the BT headphones can further include transmission wires from the base and amplifier to one or two speakers adapted for fitting in or on a wearer’s ears. The speakers can be incorporated into earpieces, such as earbuds or the like. The apparatus is configured and arranged such that a distance between the BT transmitting antennas and BT receiving antennas is short, i.e., approximately 20 cm or less, and preferably less than 5 cm.

In some implementations, a system includes BT headphones, and an attachment mechanism for a separate BT transmitter (i.e., a smart watch with a digital audio player, a dedicated digital media player, or the like) to be located and attached on or near the BT headphones. The attachment mechanism allows the BT connection to be uninterrupted while the system is submerged in water. The attachment mechanism can use elastic materials such as rubber or plastic to allow the attachment of different sizes of BT transmitters, while also securing the BT transmitter to the attachment mechanism, particularly when the wearer is active and underwater. In some instances, the attachment mechanism can be a cradle or other receptacle into which the BT transmitter is snapped and held. The attachment mechanism can utilize one or more latches, pins, tangs, tabs, protrusions, or the like. Other examples of the attachment mechanism include one or more elastic bands, such as a rubber band or a knitted mesh material.

The BT headphones can have dynamic speakers or use bone conduction speakers. These speakers may be integrated or removable from the BT headphones and can be connected with the BT transmitter via wired or wireless connection. The BT headphones can have a second attachment mechanism to further attach the headphones to another device, such as a wearable device or accessory, i.e., swim goggles. The second attachment mechanism can be a clip or hooks that enable the attachment on a headband of the swim goggles. The clip or hooks can be formed of plastic, metal, or the like, and can include magnets, snaps, latches, or the like.

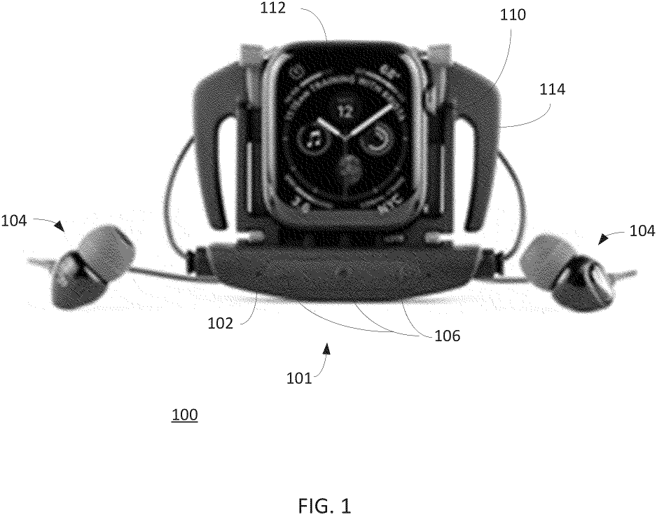

FIG. 1 illustrates a wireless communication apparatus 100 for an aquatic environment. The apparatus 100 includes a set of BT headphones 101, which includes a base 102 that has one or more BT receiving antennas, and an amplifier and other circuitry to amplify and process and/or modulate the received BT signals. The base 102 can include, inter alia, one or more user controls 106, such as volume UP, volume DOWN, play and pause, etc., as well as a number of interconnections, such as headphone jack, charging port, data port, or the like. The BT headphones further include one or more speakers 104, each configured for providing sound to an ear of a wearer. The speakers 104 can be connected with the base of the BT headphones by a signal transmission wire, or even by a second wireless hop. The speakers 104 can be earbud-type speakers, or bone conduction speakers.

The wireless communication apparatus 100 includes an attachment mechanism 110 configured and arranged to receive and hold a BT transmitter 112 in close proximity to the BT headphones 101, such as band-less smart watch or a digital music player. The base 102 next to the attachment mechanism 110 has a built-in BT that will be positioned close to the BT transmitter antenna once the BT transmitter 112 is attached. The attachment mechanism 110 can include a second attachment mechanism 114, such as protruding arms, slots, threads, screws, etc., one or in which a band, such as an elastic headband for swim goggles, can be threaded or connected to secure the attachment mechanism 110 and second attachment mechanism 114 to a wearer’s body, such as the wearer’s head. The attachment mechanism 114 can further include a waterproof encasement that encases the BT transmitter 112 or encases the receiving antennas and electronics to process and amplifier audio signals received from the BT transmitters 112. The waterproof encasement can have one or more different waterproof compartments for holding the BT transmitter 112, BT receiver, and/or BT headphones 101.

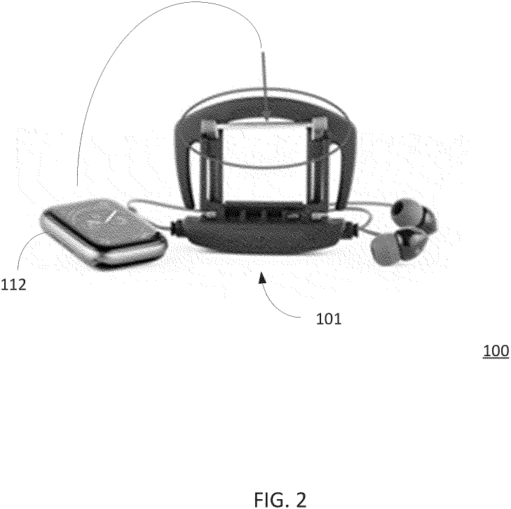

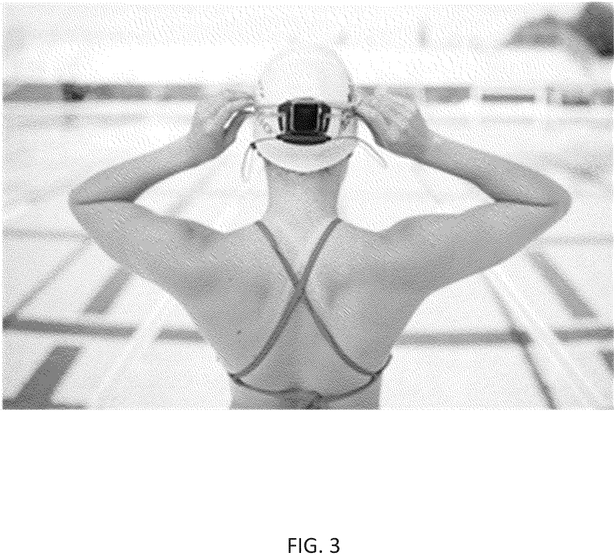

FIG. 2 shows the wireless communication apparatus 100 in which the BT transmitter 112 is removed from the attachment mechanism of the apparatus and base of the BT headphones 101. FIG. 3 illustrates the wireless communication apparatus 100 attached, via the second attachment mechanism, to a headband or goggle strap of a goggles being worn by a wearer. The wireless communication apparatus 100 can therefore receive and carry a BT transmitter, in the form of a band-less smart watch, a digital audio player device, or other BT device, and place the BT transmitter in close proximity to BT headphones, as well as in a location on the wearer where the apparatus 100 is non-obtrusive and out of the way.

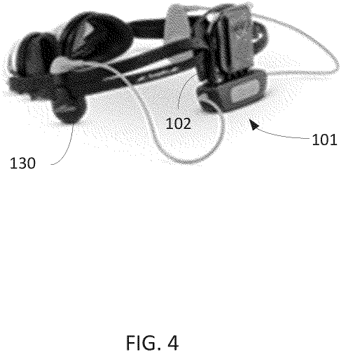

FIG. 4. shows BT headphones with bone conduction speakers 130, which can extend out from the base 102 of the BT headphones 101, such as from the bast 102 or the attachment mechanism. The bone conduction speakers are each located on a distal end of semi-rigid holding arm that extends outward and sideways from a main attachment member.

Although a few embodiments have been described in detail above, other modifications are possible. Other embodiments may be within the scope of the following claims.

1. A wireless communication apparatus for an aquatic environment, the apparatus comprising:
a base having one or more wireless receiver antennas;
a first attachment mechanism connected with the base for receiving and holding a wireless transmitter, the wireless transmitter having one or more wireless transmission antennas for transmitting audio signals, the first attachment mechanism being configured to position the one or more wireless transmission antennas of the wireless transmitter within less than approximately 20 centimeters from the one or more wireless receiver antennas of the base; and
one or more earphones connected with the base, each of the one or more earphones having a speaker for providing the audio signals from the wireless transmitter to a wearer’s ears.

2. The apparatus in accordance with claim 1, wherein the base further includes an amplifier and processing circuitry for amplifying and processing wireless signals received from the wireless transmitter.

3. The apparatus in accordance with claim 1, wherein the one or more wireless transmission antennas and the one or more wireless receiver antennas are configured for transmitting and receiving Bluetooth signals.

4. The apparatus in accordance with claim 1, wherein the first attachment mechanism is configured to position the wireless transmitter within 5 centimeters of the base.

5. The apparatus in accordance with claim 1, wherein the speaker of the one or more earphones is a dynamic speaker.

6. The apparatus in accordance with claim 1, wherein the speaker of the one or more earphones is a bone conducting speaker.

7. The apparatus in accordance with claim 1, further comprising a second attachment mechanism connected with the base, the second attachment mechanism being configured to attach to an object to position the apparatus on the wearer’s head.

8. The apparatus in accordance with claim 1, wherein the base further includes one or more user controls for controlling one or more aspects of the audio signals.

9. A wireless communication system for an aquatic environment and configured to attach to a headband, the system comprising:
a base having one or more wireless receiver antennas and one or more user controls;
a first attachment mechanism connected with the base for receiving and holding a wireless transmitter, the wireless transmitter having one or more wireless transmission antennas for transmitting audio signals, the first attachment mechanism being configured to position the one or more wireless transmission antennas of the wireless transmitter within less than approximately 20 centimeters from the one or more wireless receiver antennas of the base;
one or more earphones connected with the base, each of the one or more earphones having a speaker for providing the audio signals from the wireless transmitter to a wearer’s ears; and
a second attachment mechanism configured to connect with the headband.

10. The system in accordance with claim 9, wherein the base further includes an amplifier and processing circuitry for amplifying and processing wireless signals received from the wireless transmitter.

11. The system in accordance with claim 9, further comprising a waterproof enclosure for receiving and holding the wireless transmitter.

12. The system in accordance with claim 9, wherein the first attachment mechanism is configured to position the wireless transmitter within 5 centimeters of the base.
